(19) United States
(12) Patent Application Publication
(10) Pub. No.: US 2025/0229622 A1
(43) Pub. Date: Jul. 17, 2025

(54) DRIVE DEVICE FOR HYBRID ELECTRIC VEHICLE

(71) Applicant: Toyota Jidosha Kabushiki Kaisha, Toyota-shi (JP)

(72) Inventor: Junichiro YASUI, Seto-Shi (JP)

(73) Assignee: Toyota Jidosha Kabushiki Kaisha, Toyota-shi (JP)

(21) Appl. No.: 18/908,799

(22) Filed: Oct. 8, 2024

(30) Foreign Application Priority Data
Jan. 11, 2024 (JP) 2024-002883

(51) Int. Cl. B60K 6/405; B60K 1/02; B60K 26/00

(52) U.S. Cl. CPC B60K 6/405; B60K 1/02; B60K 26/00

(57) ABSTRACT

The case of the drive device is fastened to an engine and includes a first electric motor, a motive power distribution mechanism, a second electric motor, a driven gear mechanism, a “first case” that houses a differential gear, and a “second case” (rear cover) that is fastened so as to close an opening opposite to the engine of the “first case”, and an in-vehicle unit that also serves as a vibration restraining member is disposed at a position overlapping with a line segment that connects the first axis line and the third axis line on the “second case” (rear cover). As a result, the vibration of the rear cover is reduced by the mass of the in-vehicle unit, so that the generation of noise can be suppressed without increasing the number of components.

### CROSS-REFERENCE TO RELATED APPLICATION

This application claims priority to Japanese Patent Application No. 2024-002883 filed on Jan. 11, 2024, incorporated herein by reference in its entirety.

### BACKGROUND

### 1. Technical Field

The present Invention relates to a drive device for a hybrid electric vehicle.

### 2. Description of Related Art

A drive device for a hybrid electric vehicle having a following configuration is well known. In the hybrid electric vehicle, a first electric motor and a motive power distribution mechanism are disposed on a first axis line, a driven gear mechanism is disposed on a second axis line, a second electric motor is disposed on a third axis line, and a differential gear is disposed on a fourth axis line. The first electric motor, the motive power distribution mechanism, the second electric motor, the driven gear mechanism, and the differential gear are housed in a case. The motive power distribution mechanism includes a first electric motor and an output rotating member provided with a drive gear, and distributes and transmits motive power from an engine to the first electric motor and the output rotating member. The driven gear mechanism includes a driven gear that meshes with the drive gear. The second electric motor is coupled to the driven gear mechanism. The differential gear is coupled to the driven gear mechanism. For example, a hybrid drive device according to Japanese Unexamined Patent Application Publication No. 2020-50042 (JP 2020-50042 A) is the hybrid drive device described above. JP 2020-50042 A discloses a technique for restraining generation of gear noise in a hybrid drive device. Specifically, an outer surface of the case is fastened to an actuator of a parking lock mechanism via a bracket. The outer surface of the case fastened to the actuator of the parking lock mechanism is located across the first axis line from the side where a meshing part between the drive gear and the driven gear is located.

### SUMMARY

Noise of the drive device is generated in the meshing part between the drive gear and the driven gear and is also generated when vibration, caused by other gears, electric motors, or the like, causes the case of the drive device to vibrate. In the configuration of the case, since a portion having a flat and a wide surface has low rigidity and easily vibrates, noise is likely to be generated in the portion. When the case of the drive device is constituted of a first case and a second case as shown below, noise is likely to be generated. The first case is fastened to the engine and houses built-in components of the drive device. The second case is configured in a lid shape to be fastened so as to close an opening of the first case on the opposite side of the engine. Since the second case has a flat and wide surface shape, noise is likely to be generated. Vibrations of the first electric motor and the second electric motor propagate from respective rotation shaft support parts of the first electric motor and the second electric motor provided in the second case. When a portion having a flat and wide surface located between the respective rotation shaft support parts, that is, a portion that is easily vibrated, is largely vibrated, noise is generated. To cope with the noise, a mass damper, a soundproof cover, and the like, are added, and this causes a problem of increase in the number of components.

In a case where an electric power control unit for controlling electric power of an electric motor is integrated in the drive device as a machine-electric integrated device, the electric power control unit is disposed, for example, above the drive device. In order to secure a maintenance area of the electric power control unit, an attachment bearing surface for a vehicle body mounting member, which is conventionally provided above the drive device, may be provided in the second case. In this case, there is a problem that the vibration from a vehicle body propagates to the second case through the attachment bearing surface, and thereby noise is more likely to be generated.

The present disclosure has been made in view of the above circumstances, and an object thereof is to provide a drive device for a hybrid electric vehicle capable of restraining generation of noise without increasing the number of components.

The gist of a first aspect of the present Invention is as follows. The Invention provides a drive device for a hybrid electric vehicle, in which (a) a first electric motor and a motive power distribution mechanism are disposed on a first axis line, the motive power distribution mechanism including an output rotating member provided with a drive gear to distribute and transmit motive power from an engine to the first electric motor and the output rotating member,
a driven gear mechanism is disposed on a second axis line, the driven gear mechanism having a driven gear that meshes with the drive gear,
a second electric motor to be coupled to the driven gear mechanism is disposed on a third axis line,
a differential gear to be coupled to the driven gear mechanism is disposed on a fourth axis line,
the first electric motor, the motive power distribution mechanism, the second electric motor, the driven gear mechanism, and the differential gear are housed in a case,
(b) the case includes a first case and a second case, the first case being fastened to the engine and housing the first electric motor, the motive power distribution mechanism, the second electric motor, the driven gear mechanism, and the differential gear, the second case being fastened so as to close an opening of the first case on an opposite side of the engine, and
(c) an in-vehicle unit that also serves as a vibration restraining member is disposed at a position overlapping with a line segment connecting the first axis line and the third axis line on the second case.

According to the first aspect of the present Invention, the case is fastened to the engine and includes a first case and a second case. The first case houses the first electric motor, the motive power distribution mechanism, the second electric motor, the driven gear mechanism, and the differential gear. The second case is fastened so as to close an opening of the first case on the opposite side of the engine. The in-vehicle unit that also serves as a vibration restraining member is disposed at a position overlapping with a line segment connecting the first axis line and the third axis line on the second case. Accordingly, in addition to an original function of the in-vehicle unit, the in-vehicle unit can also reduce, by the mass thereof, the vibration of the second case that is generated through propagation from the first electric motor and the second electric motor. This makes it possible to restrain noise generation without increasing the number of components.

### BRIEF DESCRIPTION OF THE DRAWINGS

Features, advantages, and technical and industrial significance of exemplary embodiments of the Invention will be described below with reference to the accompanying drawings, in which like signs denote like elements, and wherein:

FIG. 1 is a diagram illustrating an exemplary schematic configuration of a hybrid electric vehicle to which the present disclosure is applied;

FIG. 2 is a diagram for explaining an example of an electrical configuration related to control of an electric motor and the like;

FIG. 3 is a diagram illustrating an example of a schematic configuration of a drive device;

FIG. 4 is a view for explaining an exemplary arrangement of an in-vehicle unit, which also serves as a vibration restraining member to which the present disclosure is applied, on a drive device; and

FIG. 5 is a diagram for explaining an example of the arrangement in the case where the attachment bearing surface of the vehicle body mount member is provided in the arrangement of the in-vehicle unit of FIG. 4.

### DETAILED DESCRIPTION OF EMBODIMENTS

Hereinafter, examples of the present Invention will be described in detail with reference to the drawings.

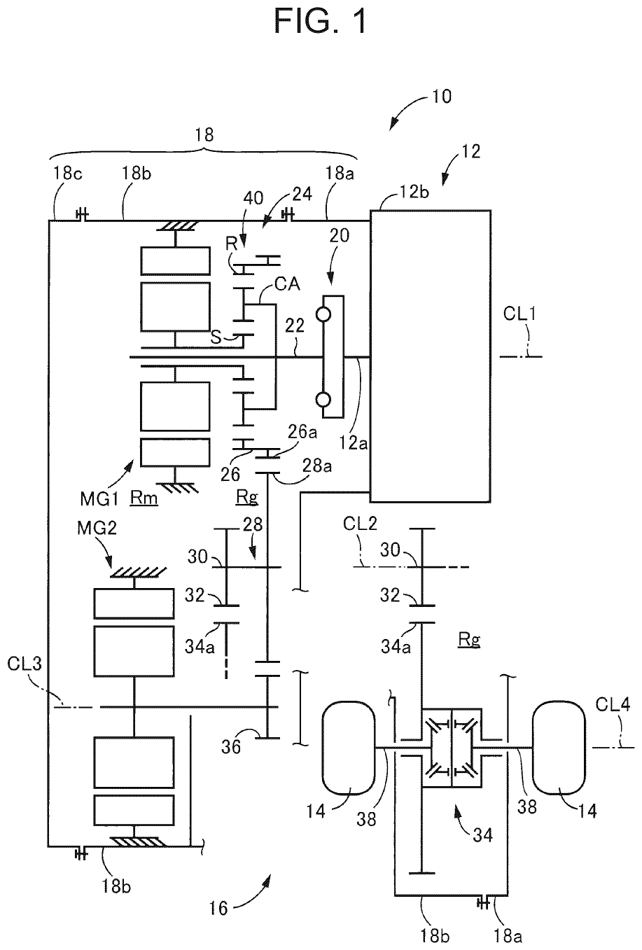

FIG. 1 is a diagram for explaining an exemplary schematic configuration of a hybrid electric vehicle (hereinafter referred to as a vehicle) 10 to which the present disclosure is applied. In FIG. 1, a vehicle 10 is a hybrid electric vehicle including an engine 12 functioning as a power source and a second electric motor MG2 serving as an electric motor functioning as a power source. Further, the vehicle 10 includes drive wheels 14, a power transmission device 16, and a first electric motor MG1.

The engine 12 is a known internal combustion engine. The drive wheels 14 are left and right wheels with respect to the forward-backward direction of the vehicle 10. The power transmission device 16 is provided in a power transmission path between the engine 12 and the drive wheels 14 and in a power transmission path between the second electric motor MG2 and the drive wheels 14.

The first electric motor MG1 and the second electric motor MG2 are known rotary electric machines each having a function as an engine for generating mechanical power from electric power and a function as a generator for generating electric power from mechanical power, and are so-called motor generators. The first electric motor MG1 and the second electric motor MG2 are provided in a non-rotatable case 18 which is a non-rotatable member attached to the vehicle body.

The power transmission device 16 includes, in the case 18, a damper 20, an input shaft 22, a transmission unit 24, a composite gear 26, a driven gear mechanism 28, a differential gear 34, a reduction gear 36, and the like. The power transmission device 16 includes a pair of drive shafts 38 and the like connected to the differential gear 34. Further, the driven gear mechanism 28 includes a driven gear 28a, a driven shaft 30, and a final gear 32, and the driven gear 28a and the final gear 32 are fixed by the driven shaft 30 so as not to be relatively rotatable.

The damper 20 is connected to the crankshaft 12a of the engine 12. The input shaft 22 functions as an input rotation member of the transmission unit 24. The input shaft 22 is connected to the damper 20, and is connected to the crankshaft 12a via the damper 20 and the like. The transmission unit 24 is connected to the input shaft 22. The composite gear 26 is an output rotating member of the transmission unit 24. In the composite gear 26, a drive gear 26a is formed on a part of the outer peripheral surface. The driven gear 28a meshes with the drive gear 26a. The final gear 32 has a smaller diameter than the driven gear 28a and meshes with the differential ring gear 34a. The reduction gear 36 has a smaller diameter than the driven gear 28a and meshes with the driven gear 28a. A rotor shaft of the second electric motor MG2 is connected to the reduction gear 36, and the second electric motor MG2 is connected so as to be able to transmit power.

The power transmission device 16 configured as described above is suitably used for vehicles of FF (front engine/front drive) type or RR (rear engine/rear drive) type. The power transmission device 16 transmits the power output from the engine 12 to the driven gear mechanism 28 via the transmission unit 24. In addition, the power transmission device 16 connects the second electric motor MG2 and the driven gear mechanism 28 via the reduction gear 36 so as to be able to transmit power. Further, the power transmission device 16 connects the driven gear mechanism 28 and the differential gear 34 so as to be able to transmit power, and transmits the power transmitted to the differential gear 34 to the drive wheels 14 via the drive shafts 38 and the like. The driven gear mechanism 28 is a transmission mechanism that transmits power from the second electric motor MG2 to the differential gear 34, and is a transmission mechanism that transmits power from the drive gear 26a to the differential gear 34. The differential gear 34 distributes power from the engine 12 and the second electric motor MG2 to the drive wheels 14. The drive shafts 38 transmit power from the differential gear 34 to the drive wheels 14. The second electric motor MG2 is connected to the drive wheels 14 so as to be capable of transmitting power.

The transmission unit 24 includes a first electric motor MG1 and a motive power distribution mechanism 40. The motive power distribution mechanism 40 is a known single pinion type planetary gear set including a sun gear S, a carrier CA, and a ring gear R. The sun gear S is connected to the rotor shaft of the first electric motor MG1. That is, the motive power distribution mechanism 40, which is a part of the power transmission device 16, is connected to a first electric motor MG1 as an electric motor so as to be capable of transmitting power. The carrier CA is connected to the input shaft 22. That is, the motive power distribution mechanism 40 is connected to the engine 12 via the input shaft 22 or the like so as to be capable of transmitting power. The ring gear R is formed on a part of the inner circumferential surface of the composite gear 26 and is integrally connected to the drive gear 26a. That is, the motive power distribution mechanism 40 is connected to the drive wheels 14 so as to be capable of transmitting power.

The motive power distribution mechanism 40 is a motive power distribution mechanism that mechanically divides the power of the engine 12 inputted to the carrier CA into a first electric motor MG1 and a drive gear 26a. The transmission unit 24 is a known electric transmission mechanism in which the power distribution state of the motive power distribution mechanism 40 is controlled by controlling the operation state of the first electric motor MG1.

The power transmission device 16 has a first axis line CL1, a second axis line CL2, a third axis line CL3, and a fourth axis line CL4. These four axis lines CL1, CL2, CL3, CL4 are parallel to each other. The first axis line CL1 is an axis line center of the rotor shaft of the input shaft 22 or the first electric motor MG1. That is, the first axis line CL1 is the rotational axis line of the first electric motor MG1. The first electric motor MG1 and the motive power distribution mechanism 40 are disposed on the first axis line CL1. The second axis line CL2 is an axis line center of the driven shaft 30, and the driven gear mechanism 28 are disposed on the second axis line CL2. That is, the second axis line CL2 is the rotational axis line of the driven gear mechanism 28. The third axis line CL3 is the axis line of the rotor shaft of the second electric motor MG2. That is, the third axis line CL3 is the rotational axis line of the second electric motor MG2. The second electric motor MG2 and the reduction gear 36 are disposed on the third axis line CL3. The fourth axis line CL4 is an axis line of the drive shafts 38 and an axis line of the differential gear 34. That is, the fourth axis line CL4 is the rotational axis line of the drive shafts 38 and the differential gear 34. The differential gear 34 is disposed on the fourth axis line CL4. The second axis line CL2 and the fourth axis line CL4 are rotational axes of the power transmission device 16.

The case 18 includes a housing 18a, a case body 18b, and a rear cover 18c. In the housing 18a, an engine block 12b of the engine 12 is fastened to an opened part of the engine 12. The housing 18a and the case body 18b are integrally fastened by fasteners such as bolts so that an opened portion of the housing 18a facing away from the engine 12 and an opened portion of the case body 18b facing toward the engine 12 are aligned. The case body 18b and the rear cover 18c are integrally fastened by fasteners so as to close an open part of the case body 18b facing away from the engine 12 with the rear cover 18c. The case body 18b includes a partition wall (not shown). The partition partitions the gear chamber Rg that houses the motive power distribution mechanism 40, the driven gear mechanism 28, the differential gear 34, and the like, and the motor chamber Rm that houses the first electric motor MG1 and the second electric motor MG2. The case body 18b forms a gear chamber Rg with the housing 18a. The case body 18b forms a motor chamber Rm with the rear cover 18c. As described above, the case 18 houses the first electric motor MG1, the second electric motor MG2, the motive power distribution mechanism 40, the driven gear mechanism 28, the differential gear 34, and the like. The housing 18a and the case body 18b correspond to the “first case” in the present disclosure. The rear cover 18c corresponds to the “second case” in the present disclosure.

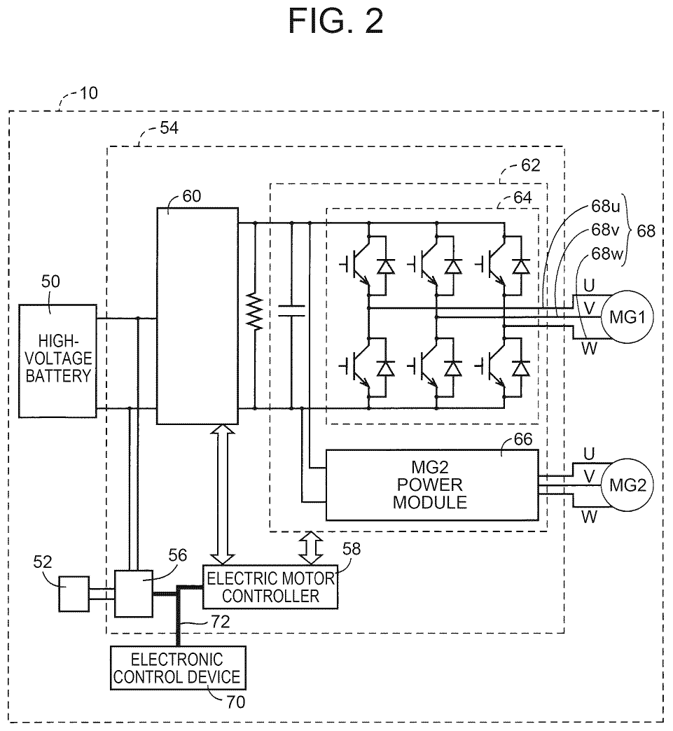

FIG. 2 is a diagram illustrating an exemplary electric configuration related to control of the first electric motor MG1, the second electric motor MG2, and the like. In FIG. 2, the vehicle 10 further includes a high-voltage battery 50, an auxiliary battery 52, an electric power control unit 54, and the like.

The high-voltage battery 50 is a chargeable/dischargeable DC power source, and is a secondary battery such as a nickel-hydrogen secondary battery or a lithium-ion battery. The high-voltage battery 50 is connected to the electric power control unit 54. The stored electric power is supplied from the high-voltage battery 50 to, for example, the second electric motor MG2 via the electric power control unit 54. The high-voltage battery 50 is supplied with electric power by the power generation control of the first electric motor MG1 and electric power by the regenerative control of the second electric motor MG2 via the electric power control unit 54. The high-voltage battery 50 corresponds to a “battery” in the present Invention.

The electric power control unit 54 includes a DCDC converter 56, an electric motor control device 58, a step-up converter 60, an inverter 62, and the like. The electric power control unit 54 is a power control device that controls electric power exchanged between the high-voltage battery 50 and the first electric motor MG1 and the second electric motor MG2.

DCDC converters 56 are connected to the high-voltage battery 50. DCDC converter 56 functions as a charging device that reduces the voltage of the high-voltage battery 50 to a voltage equivalent to that of the auxiliary battery 52 and charges the auxiliary battery 52. The auxiliary battery 52 supplies electric power for operating an auxiliary machine, an electric motor control device 58, an electronic control device 70 to be described later, and the like provided in the vehicle 10.

The step-up converter 60 includes a reactor, a switching element, and the like (not shown). The step-up/step-down converter 60 is a step-up/step-down circuit having a function of boosting the voltage of the high-voltage battery 50 and supplying the voltage to the inverter 62, and a function of stepping down the voltage converted into a direct current by the inverter 62 and supplying the stepped-down voltage to the high-voltage battery 50.

The inverter 62 includes a MG1 power module 64, a MG2 power module 66, and the like. MG1 power module 64 includes a plurality of transistors and the like that are turned on and off as switching elements to convert a direct current into a three-phase alternating current, and constitutes a U-phase, V-phase, and W-phase three-phase bridging circuit. The vehicle 10 further includes a busbar 68, and the first electric motor MG1 is electrically connected to MG1 power module 64 (i.e., the inverter 62) by the busbar 68. The busbar 68 is a power line that electrically connects the first electric motor MG1 and the electric power control unit 54, and includes a plurality of busbars 68u, 68v, 68w. The plurality of busbars 68u, 68v, 68w are three power lines for supplying three-phase alternating current of U-phase, V-phase, and W-phase. MG2 power module 66 is similar in configuration to MG1 power module 64, and therefore the explanation of MG2 power module 66 is omitted. Each of the first electric motor MG1 and the second electric motor MG2 is a three-phase AC synchronous motor driven by the inverter 62.

Inverter 62 converts the direct current from step-up converter 60 into an alternating current for driving first electric motor MG1 and second electric motor MG2. The inverter 62 converts an alternating current generated by the first electric motor MG1 by the power of the engine 12 and an alternating current generated by the second electric motor MG2 by the regenerative braking into a direct current. The inverter 62 supplies the alternating current generated by the first electric motor MG1 as the driving power of the second electric motor MG2 in accordance with the running condition.

The vehicle 10 further includes an electronic control device 70, a communication line 72, and the like. The electronic control device 70 transmits and receives signals to and from DCDC converters 56, the electric motor control device 58, and the like via the communication line 72. The electronic control device 70 performs various types of control of the vehicle 10 based on a signal from, for example, a sensor (not shown). The communication line 72 is, for example, a known controller area network (CAN) communication line.

The electric motor control device 58 controls the step-up converter 60 and the inverter 62 based on commands from the electronic control device 70, and controls the first electric motor MG1 and the second electric motor MG2. For example, the motor control device 58 converts a direct current from the high-voltage battery 50 into an alternating current used for the first electric motor MG1 and the second electric motor MG2. The motor control device 58 drives the first electric motor MG1 in order to secure a power generation required to supply electric power to the second electric motor MG2 and to charge the high-voltage battery 50. The motor control device 58 drives the second electric motor MG2 on the basis of a required value corresponding to a required torque of the driver. The motor control device 58 causes the second electric motor MG2 to function as a generator in accordance with the required quantity of the regenerative braking.

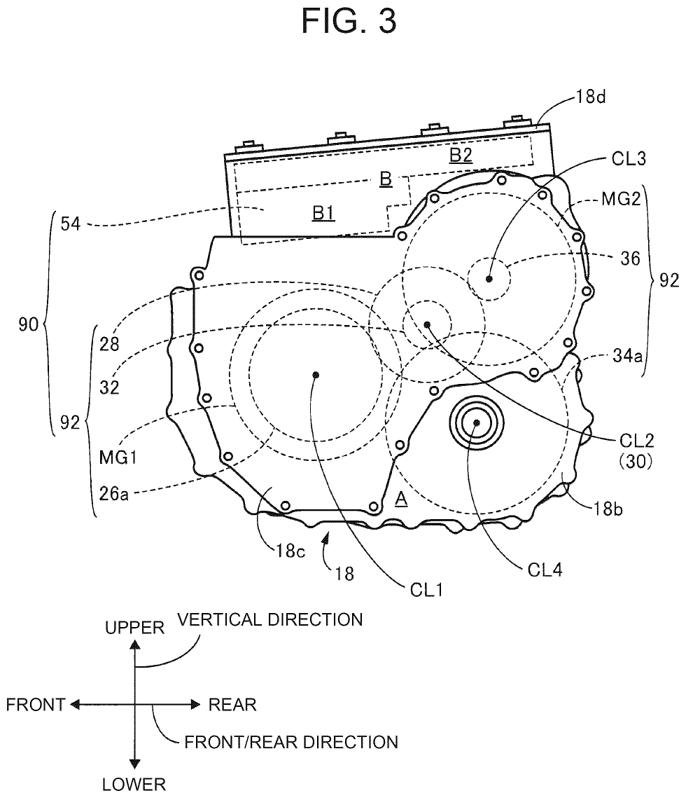

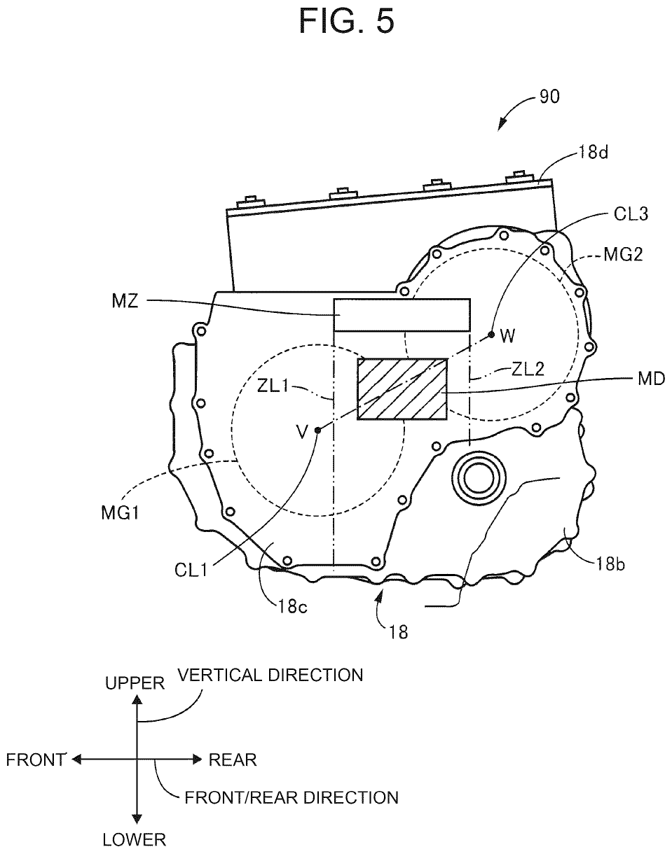

FIG. 3 is a diagram illustrating an example of a schematic configuration of the drive device 90. FIG. 3 is a side view from the left side of the vehicle 10. In FIG. 3, the transaxle 92 and the electric power control unit 54 are housed in the same case 18 as the drive device 90. The drive device 90 is a device in which the transaxle 92 and the electric power control unit 54 are integrated, that is, an electromechanical integrated device. The transaxle 92 is a drive device including a power transmission device 16 (20, 28, 34, 36, 40, etc.), a first electric motor MG1, and a second electric motor MG2. In the drawings, the vertical direction, the forward-backward direction, and the vehicle width direction (see FIG. 5) indicate directions in the mounted state of the vehicle 10. The widthwise direction is an axial direction of each of the first axis line CL1, the second axis line CL2, the third axis line CL3, and the fourth axis line CL4.

The case 18 further includes a protective plate 18d in addition to the housing 18a, the case body 18b, and the rear cover 18c described above. The case body 18b has a bottom wall and a side wall extending vertically upward from an outer peripheral edge of each of the front and rear sides of the bottom wall, and an upper portion in the vertical direction is opened. The protective plate 18d is a plate-shaped member that closes an opening in a vertical upper portion of the case body 18b. The case body 18b has a partition wall (not shown) inside, and is partitioned by the partition wall into two spaces: a lower space A, which is a space in the vertical lower direction, and an upper space B, which is an upper space in the vertical direction. In the drive device 90 which is an electromechanical integrated device, the housing 18a, the case body 18b, and the protective plate 18d correspond to the “first case” in the present disclosure.

The transaxle 92 is accommodated in the lower space A and the housing 18a of the case body 18b in the mounted condition of the vehicle 10.

The electric power control unit 54 is accommodated in the upper space B of the case body 18b in the mounted condition of the vehicle 10. The upper space B includes the uppermost space B2 at the vertical upper part of the second electric motor MG2 and the excess space B1 generated by the arrangement of the first electric motor MG1 and the second electric motor MG2. The length of the excess space B1 is shorter than the length of the uppermost space B2 in the forward-backward direction. The electric power control unit 54 is disposed vertically above and adjoins the first electric motor MG1 in the mounted condition of the vehicle 10.

In the excess space B1, for example, DCDC converter 56 and a reactor (not shown) included in the step-up converter 60 are accommodated in the electric power control unit 54, considering that the components are relatively short-length components or components that are relatively easy to replace.

Referring to FIG. 3, the transaxle 92 is disposed such that the first axis line CL1, the second axis line CL2, the third axis line CL3, and the fourth axis line CL4 are parallel to the horizontal direction perpendicular to the forward/reverse direction of the vehicle 10 in the mounted condition of the vehicle 10. In addition, in the mounted condition of the vehicle 10, the positions of the first axis line CL1, the second axis line CL2, the third axis line CL3, and the fourth axis line CL4 of the transaxle 92 are arranged as follows. The second electric motor MG2, the driven shaft 30, the first electric motor MG1, and the differential gear 34 are arranged in this order from the upper side to the lower side in the vertical direction, and the first electric motor MG1, the driven shaft 30, the differential gear 34, and the second electric motor MG2 are arranged in this order from the front side to the rear side in the forward and backward direction. Focusing on the first electric motor MG1 and the second electric motor MG2, the transaxle 92 is disposed in the order of the third axis line CL3 and the first axis line CL1 from the vertical upper side to the lower side in the mounted condition in the vehicle 10. As a result, the vertical size of the transaxle 92 is reduced while the distance between the axes of the first axis line CL1, the second axis line CL2, the third axis line CL3, and the fourth axis line CL4 is appropriately secured. Thus, the arrangement of the first electric motor MG1 and the second electric motor MG2 creates an excess space B1 and the uppermost space B2 at the vertical top of the second electric motor MG2. The electric power control unit 54 is mounted in the upper space B (B1+B2).

The electric power control unit 54 is disposed vertically above the transaxle 92 in the mounted state of the vehicle 10. In addition, in the mounted state of the vehicle 10, the electric power control unit 54 is disposed at a position where the lower portion of the electric power control unit 54 in the vertical direction overlaps the transaxle 92 as viewed in the forward and backward directions. In particular, the vertical lower portion of the electric power control unit 54 horizontally overlaps the vertical upper portion of the second electric motor MG2. In other words, in the electric power control unit 54, the lower part of the electric power control unit 54 in the vertical direction is disposed above the first electric motor MG1 in the mounted condition of the vehicle 10. The vertically lower part of the electric power control unit 54 is, for example, a component (e.g., a DCDC converter 56, a reactor) accommodated in the excess space B1 of the electric power control unit 54.

An electric power control unit 54 is mounted in the space created by the reduced vertical size of the transaxle 92, creating space above the drive device 90 in the vertical direction.

Noise in the drive device 90, which is a problem to be solved by the present disclosure, is generated when vibration caused by the inner gears, the first electric motor MG1, the second electric motor MG2, and the like causes the case 18 of the drive device 90 to vibrate. In the case configuration, a portion having a flat surface and a wide surface tends to vibrate with low rigidity, so that noise is likely to be generated. When the case 18 is formed of a “first case” (housing 18a, case body 18b, protective plate 18d) fastened to the engine 12 and accommodating a built-in component of the drive device 90, and a lid-shaped “second case” (rear cover 18c) fastened so as to close an opening of the first case facing away from the engine 12, the rear cover 18c has a flat and wide surface shape, so that noises are likely to occur. Vibrations of the first electric motor MG1 and the second electric motor MG2 propagate from respective rotary shaft supports of the first electric motor MG1 and the second electric motor MG2 provided on the rear cover 18c. Further, noise is generated by largely vibrating a portion located between the respective rotation shaft support portions, which is flat and has a wide surface, that is, a portion which is easily vibrated. To cope with the noise, a mass damper, a soundproof cover, and the like, are added, and this causes a problem of increase in the number of components.

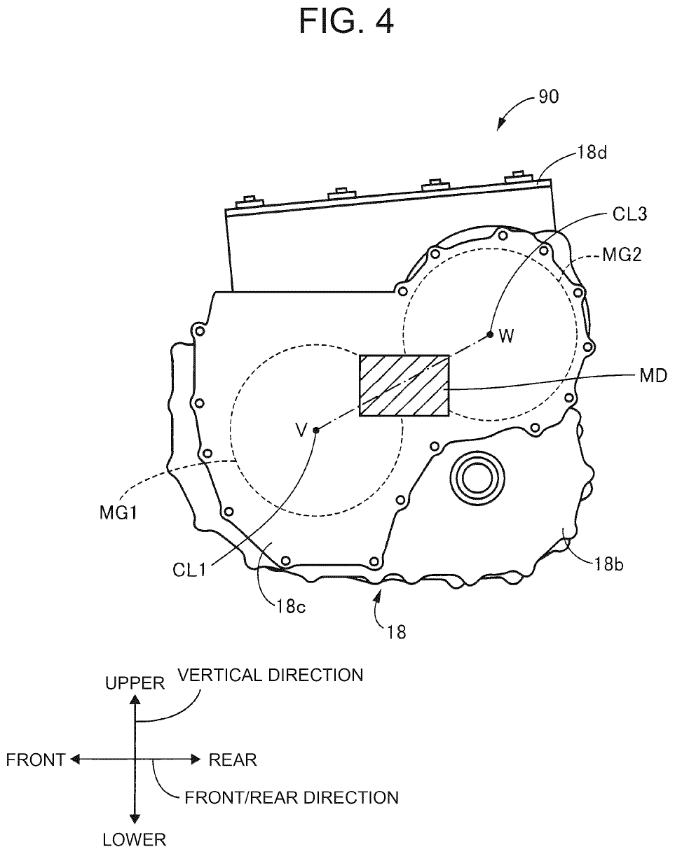

Therefore, in the drive device 90 of the present embodiment, as shown in FIG. 4, the in-vehicle unit MD is disposed on the rear cover 18c at the vibratory position located between the respective rotary shaft support portions of the first electric motor MG1 and the second electric motor MG2. The in-vehicle unit MD is a unit that also serves as a vibration restraining member having a weight m. By arranging the in-vehicle unit MD so as to make the above-described vibration-prone portion less likely to vibrate, the vibration is reduced. In FIG. 4, the in-vehicle unit MD having the weight m is disposed at a position overlapping the line segment VW connecting the intersection point V between the rear cover 18c surface and the first axis line CL1 and the intersection point W between the rear cover 18c surface and the third axis line CL3. In FIG. 4, the line segment VW is indicated by a dashed-dotted line. As a result, the oscillation of the rear cover 18c propagated from the first electric motor MG1 and the second electric motor MG2 is reduced by the arrangement of the in-vehicle unit MD having the mass m.

In the in-vehicle unit MD, for example, an oil cooler is disposed. Further, for example, an electric oil pump is disposed. Further, for example, DCDC converters 56 and the like may be transferred from the electric power control unit 54 and arranged. Further, as for the arrangement of the in-vehicle unit MD on the rear cover 18c, fastening using bolts or the like, fixing via mounting brackets, or the like is preferably performed. In addition, the rear cover 18c may be preferably formed so as to integrally accommodate the in-vehicle unit MD.

In addition, as in the present embodiment, when the electric power control unit 54 is disposed in the upper portion of the drive device 90 as the electromechanical integrated device, the attachment bearing surface MZ of the vehicle body mounting member is provided on the rear cover 18c. The attachment bearing surface MZ is conventionally provided at an upper portion of the drive device 90 in order to secure a maintenance-area of the electric power control unit 54. In this case, the vibration from the vehicle body is propagated to the rear cover 18c through the attachment bearing surface MZ, and further noise is likely to be generated.

FIG. 5 is a diagram illustrating an exemplary arrangement of the in-vehicle unit MD when the rear cover 18c is provided with the attachment bearing surface MZ of the vehicle body mounting member. In FIG. 5, the rear cover 18c includes an attachment bearing surface MZ of the vehicle body mounting member vertically above the line segment VW (dashed-dotted line). The portion where the rear cover 18c is likely to vibrate due to the propagation of the vehicle body vibrations from the attachment bearing surface MZ is a range immediately below the vertical direction of the attachment bearing surface MZ, that is, a range sandwiched between the two-dot chain line ZL1 and ZL2 illustrated in FIG. 5. Therefore, the in-vehicle unit MD, which also serves as a vibration restraining member having a mass m, is disposed at a position that is located in a range immediately below the vertical direction of the attachment bearing surface MZ (a range sandwiched between the two-dot chain line ZL1 and ZL2) and overlaps the line segment VW. As a result, the vibrations of the rear cover 18c propagating from the first electric motor MG1 and the second electric motor MG2 and the vehicle body are reduced by the arrangement of the in-vehicle unit MD having the mass m.

As described above, according to the present embodiment, the case 18 includes the “first case” and the “second case”. The “first case” is fastened to the engine 12 and houses the first electric motor MG1, the motive power distribution mechanism 40, the second electric motor MG2, the driven gear mechanism 28, and the differential gear 34. (The “first case” includes a housing 18a, a case body 18b, and a protective plate 18d). The “second case” is fastened so as to close the opening of the “first case” facing away from the engine 12. (The second case includes a rear cover 18c.) The case 18, on the second case (rear cover 18c), connecting the first axis line CL1 and the third axis line CL3, the line segment VW and the overlapping position, the in-vehicle unit MD also serving as a vibration restraining member arranged. Accordingly, in addition to the original roles of the in-vehicle unit MD, the masses m of the in-vehicle unit MD reduces the vibrations of the rear cover 18c generated due to the vibrations propagating from the first electric motor MG1 and the second electric motor MG2. Therefore, noise generation can be suppressed without increasing the number of components.

Further, according to the present embodiment, the “first case” (the housing 18a, the case body 18b, and the protective plate 18d) houses the electric power control unit 54. Thus, even in the drive device 90 in which the electric power control unit 54 is integrated as the electromechanical integrated device, it is possible to suppress the generation of noise without increasing the number of components.

Further, according to the present embodiment, the “second case” (rear cover 18c) is provided with the attachment bearing surface MZ of the vehicle body mounting member vertically above the line segment VW. An in-vehicle unit MD which also serves as a vibration restraining member is arranged in a vertical area directly below the attachment bearing surface MZ. In addition to the original roles of the in-vehicle unit MD, the mass m of the in-vehicle unit MD reduces the vibrations of the rear cover 18c generated due to the vibrations propagating from the first electric motor MG1 the second electric motor MG2, and the vehicle body. Therefore, noise generation can be suppressed without increasing the number of components.

Although the examples of the present Invention have been described in detail with reference to the drawings, the present Invention also applies to other modes.

For example, in the above-described embodiment, the electric power control unit 54 is incorporated in the drive device 90 as the electromechanical integrated device, but the electric power control unit 54 may be configured as a separate device.

It should be noted that the examples described above are merely embodiments, and the present Invention can be implemented in a mode in which various changes and improvements are made based on the knowledge of those skilled in the art.

What is claimed is:

1. A drive device for a hybrid electric vehicle, wherein:
a first electric motor and a motive power distribution mechanism are disposed on a first axis line, the motive power distribution mechanism including an output rotating member provided with a drive gear to distribute and transmit motive power from an engine to the first electric motor and the output rotating member;
a driven gear mechanism is disposed on a second axis line, the driven gear mechanism having a driven gear that meshes with the drive gear;
a second electric motor to be coupled to the driven gear mechanism is disposed on a third axis line;
a differential gear to be coupled to the driven gear mechanism is disposed on a fourth axis line;
the first electric motor, the motive power distribution mechanism, the second electric motor, the driven gear mechanism, and the differential gear are housed in a case;
the case includes a first case and a second case, the first case being fastened to the engine and housing the first electric motor, the motive power distribution mechanism, the second electric motor, the driven gear mechanism, and the differential gear, the second case being fastened so as to close an opening of the first case on an opposite side of the engine; and
an in-vehicle unit that also serves as a vibration restraining member is disposed at a position overlapping with a line segment connecting the first axis line and the third axis line on the second case.

2. The drive device according to claim 1, wherein the first case further houses an electric power control unit that controls electric power exchanged between the first electric motor and the second electric motor and a battery.

3. The drive device according to claim 1, wherein the second case includes an attachment bearing surface for a vehicle body mounting member that is provided above the line segment in a vertical direction, and the in-vehicle unit that also serves as the vibration restraining member is disposed in a range directly below the attachment bearing surface in the vertical direction.
